(19) United States
(12) Patent Application Publication
(10) Pub. No.: US 2026/0256055 A1
(43) Pub. Date: Sep. 3, 2026

(54) AUTOMATIC HARVEST STATE DETECTION AND SETTINGS CHANGE CONTROL

(71) Applicant: Deere & Company, Moline, IL (US)

(72) Inventors: Aubrey W. CLAY, JR., Rock Island, IL (US); Jeremiah K. JOHNSON, Williamsburg, IA (US); Adam J. DONOHOE, West Branch, IA (US)

(21) Appl. No.: 19/067,158

(22) Filed: Feb. 28, 2025

(51) Int. Cl. A01D 41/127

(52) U.S. Cl. CPC A01D 41/1272

(57) ABSTRACT

A harvest state of an agricultural harvester is automatically detected. If the harvest state is active, then a settings control system accesses setting values, corresponding to an active harvest state, that are automatically applied to controllable subsystems in the agricultural harvester. If the harvest state is inactive, then the setting control system accesses offset values that are automatically applied to the controllable subsystems until the harvest state returns to active.

### FIELD OF THE DESCRIPTION

The present description relates to agricultural harvesters. More specifically, the present description relates to automatically detecting the harvest state of an agricultural harvester and adjusting harvester settings based on the harvest state.

### BACKGROUND

There are many different types of agricultural harvesters. Some such harvesters include combine harvesters, forage harvesters, cotton harvesters, sugarcane harvesters, among others. Each harvester may have a wide variety of different types of control settings that can be used to control the operation of subsystems of the agricultural harvester. Such control settings can include such things as cleaning fan speed, chaffer and sieve clearance, thresher clearance, threshing rotor speed, residue handling subsystem settings, among others. The values for each of the control settings may vary based upon the quantity of material being processed by the agricultural harvester (e.g., based on the harvester throughput).

The discussion above is merely provided for general background information and is not intended to be used as an aid in determining the scope of the claimed subject matter.

### SUMMARY

A harvest state of an agricultural harvester is automatically detected. If the harvest state is active, then a settings control system accesses setting values, corresponding to an active harvest state, that are automatically applied to controllable subsystems in the agricultural harvester. If the harvest state is inactive, then the setting control system accesses offset values that are automatically applied to the controllable subsystems until the harvest state returns to active.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of one example of a harvester.

FIG. 2 is a pictorial illustration of one example of a harvester exiting a harvest state and re-entering a harvest state.

FIG. 3 is a block diagram of one example of an automatic settings change system.

FIGS. 4A and 4B (collectively referred to herein as FIG. 4) show a flow diagram illustrating one example of the operation of the automatic settings change system.

FIG. 5 graphically illustrates one example of a change in mass flow rate as the harvester moves between harvesting states.

FIG. 6 graphically illustrates one example of a change in portions of a header width in use, as the harvester moves between harvesting states.

FIG. 7 is a block diagram showing one example of the harvester in a remote server architecture.

FIGS. 8, 9, and 10 show examples of mobile devices that can be used in systems and architectures shown in other FIGS.

FIG. 11 is a block diagram of one example of a computing environment that can be used in systems and architectures shown in other FIGS.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, agricultural harvesters use a plurality of different control settings to control different subsystems that are used by the agricultural harvester. The control settings may have values that are optimized or otherwise identified based upon the amount of material that is moving through the agricultural harvester (e.g., the harvester throughput). For instance, when an agricultural harvester is in the middle of a pass harvesting material in a field, there may be a level of material that is being processed by the agricultural harvester (e.g., there may be a harvester throughput) that includes crop material that is engaged by the header, fed in through the feeder house to the thresher, separator, and cleaning shoe, and then transferred to the clean grain tank or expelled as residue. The harvester throughput may be measured by a mass flow sensor which measures the mass flow of material at one or more different points through the harvester, or the harvester throughput may be estimated using other sensors that sense variables that are responsive to harvester throughput. Such sensors may sense things such as pressure or torque used to drive a threshing rotor. In other examples, the harvester throughput may be estimated based upon other factors or other sensed values.

However, there are many times during a harvesting operation where the harvester throughput changes. For instance, as the agricultural harvester reaches the end of a pass and makes the headland turn, the harvester throughput will drop dramatically and quickly as the harvester exits the pass (where the crop is being harvested) and enters the headlands (where no crop is being harvested). Similarly, after performing a headland turn, as the harvester begins the next subsequent pass, the harvester throughput will increase suddenly when the harvester transitions from the headlands (where the header is not engaging any crop) to the next pass (where the header begins engaging crop).

When the settings values that are used to control the subsystems on the agricultural harvester are set at values that assume one harvester throughput, and where the actual harvester throughput is different, this can lead to unwanted results. For instance, the harvester can exhibit excessive grain loss, an increase in foreign material in the clean grain tank, among other things.

The present description thus proceeds with respect to a system that automatically senses the harvest state of the agricultural harvester (e.g., whether the agricultural harvester is actively harvesting the crop or not) and automatically adjusts the settings values based upon the detected harvest state. By automatically as it is meant that the step, function, or process is performed without further human involvement except, perhaps, to initiate or authorize the step, function, or process.

For instance, as the agricultural harvester is making a pass through a field, the present system detects the harvest state as active. Thus, the present system accesses settings values corresponding to an active harvest state and applies those setting values to the controllable subsystems on the agricultural harvester. However, as the agricultural harvester exits a pass to make a headland turn, the present system detects that the harvest state of the agricultural harvester has changed to inactive and accesses settings values corresponding to an inactive harvest state. The settings values corresponding to the inactive harvest state are applied to the controllable subsystems until the harvest state again changes to active.

Also, in one example, the present system accesses a coverage map to identify whether the agricultural harvester is at a location that has already been harvested, at a location that has not yet been harvested, at a location of a non-crop area (such as a waterway, etc.), or to obtain other geographical information of interest. The present system can use the information from the coverage map to control the settings values that are applied to the controllable subsystems as well. For instance, the present system may determine that the current harvest state is inactive, but the coverage map may indicate that the harvester is transitioning through a relatively short, passable non-crop area (such as a waterway). In that case, even though the harvest state is inactive (in that the agricultural harvester is not engaging crop) the present system may not change the settings values because the duration until the harvest state changes back to active is relatively short. The present system may avoid changing the settings values, in such a scenario, to avoid machine wear, or for other reasons.

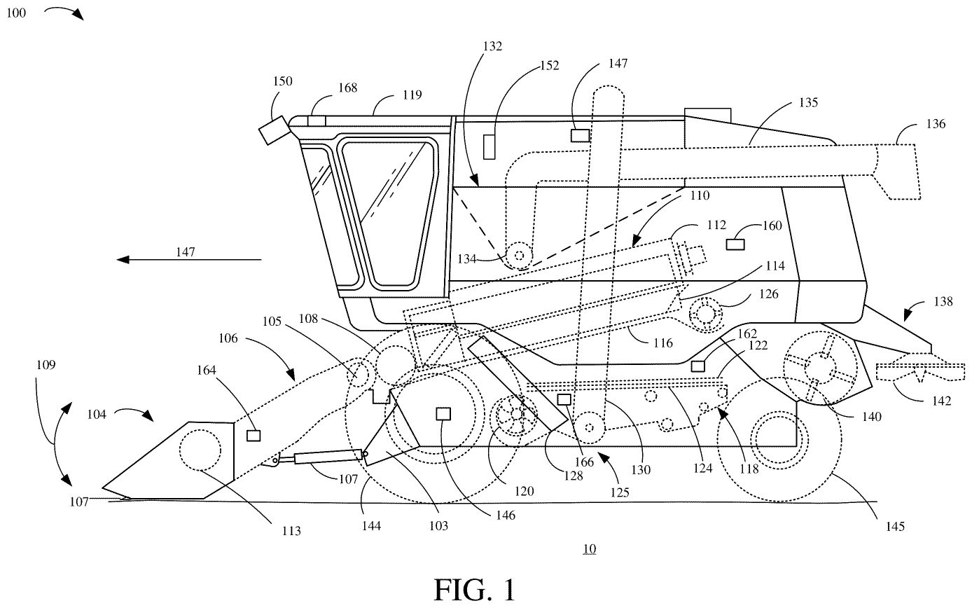

FIG. 1 is partial pictorial, partial schematic illustration of an example agricultural work machine 100 in the form of an agricultural harvester. In the example shown in FIG. 1, agricultural harvester 100 is in the form of a combine harvester. As illustrated in FIG. 1, harvester 100 includes ground engaging traction elements (wheels or tracks) 144 and 145 which can be driven by a propulsion subsystem (e.g., internal combustion engine, electric motors, hydrostatic drive, and other drivetrain elements, such as a gear box) to propel harvester 100 across a worksite 10 (e.g., a field). Harvester 100 includes an operator compartment or cab 119, which can include a variety of different operator interface mechanisms for controlling harvester 100 as well as for presenting (e.g., displaying, etc.) various information. Harvester 100 includes a feeder house 106, a feed accelerator 108, and a thresher generally indicated at 110. The feeder house 106 and the feed accelerator 108 form part of a material handling subsystem 125. Header 104 is pivotally coupled to a frame 103 of harvester 100 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100 can also include one or more actuators that operate to apply a tilt angle, a roll angle, or both to the header 104 or portions of header 104.

Agricultural harvester 100 includes a material handling subsystem 125 that includes a thresher 110 which illustratively includes a threshing rotor 112 and a set of concaves 114. Further, material handling subsystem 125 also includes a separator 116. Agricultural harvester 100 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator moves clean grain into a material receptacle (or clean grain tank) 132.

Harvester 100 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as motor or engine) to convey material from grain tank 132 through chute 135 and spout 136. Chute 135 is rotatable through a range of positions from a storage position (shown in FIG. 1) to a variety of deployed positions away from agricultural harvester 100 to align spout 136 relative to a material receptacle of a material receiving machine that is configured to receive the material within grain tank 132. Spout 136, in some examples, is also rotatable, by an actuator, to adjust the direction of the material stream exiting spout 136.

Harvester 100 also includes a residue subsystem 138 that can include chopper 140 and spreader 142.

In some examples, a harvester 100 within the scope of the present disclosure can have more than one of any of the subsystems mentioned above. In some examples, harvester 100 can have left and right cleaning subsystems, separators, etc., which are not shown in FIG. 1.

In operation, and by way of overview, harvester 100 illustratively moves through field 10 in the direction indicated by arrow 147. As harvester 100 moves, header 104 engages the crop plants to be harvested and cuts, with a cutter bar 107 on the header 104, the crop plants to generate cut crop material.

The cut crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into thresher 110. The severed crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow.

Grain falls to cleaning subsystem 118. Chaffer 122 separates some larger pieces of MOG from the grain, and sieve 124 separates some finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 100 toward the residue handling subsystem 138.

Tailings elevator 128 returns tailings to thresher 110 where the tailings are re-threshed. Alternatively, the tailings also can be passed to a separate re-threshing mechanism by a tailings elevator or another transport device where the tailings are re-threshed as well.

Harvester 100 can include a variety of sensors, some of which are illustrated in FIG. 1, such as ground speed sensor 146, one or more mass flow sensors 147, one or more observation sensor systems 150, one or more fill level sensors 152, rotor sensor (e.g., pressure sensor, torque sensor, etc) 160, separator engagement sensor 162, header engagement/usage sensor 164, tailings status sensor 166, position sensor 168, and/or other sensors.

Ground speed sensor 146 senses the travel speed of harvester 100 over the ground. Ground speed sensor 146 can sense the travel speed of the harvester 100 by sensing the speed of rotation of the ground engaging traction elements 144 or 145, or both, a drive shaft, an axle, or other components. In some instances, the travel speed can be sensed using a positioning system or positioning sensor 168.

Position sensor 168 senses the geographic position of harvester 100 in a global or local coordinate system. Position sensor 168 can be a global positioning system (GPS), a dead reckoning system, a long-range navigation (LORAN) system, a cellular triangulation system, or a wide variety of other systems or sensors that provide an indication of the position of harvester 100. Ground speed sensors 146 and/or position sensor 168 can also include direction sensors such as a compass, a magnetometer, a gravimetric sensor, a gyroscope, GPS derivation, to determine the direction of travel in two or three dimensions in combination with the speed. This way, when harvester 100 is on a slope, the orientation of harvester 100 relative to the slope can be known. For example, an orientation of harvester 100 could include ascending, descending or transversely travelling the slope.

Mass flow sensor(s) 147 sense the mass flow of material (e.g., grain). In one example, mass flow sensor 147 is mounted to sense the mass flow of grain through clean grain elevator 130. However, mass flow sensors 147 can be disposed at various locations, such as within or at the outlet of clean grain elevator 130, within feeder house 106 to sense the mass flow of material through feeder house 106, or at other locations to sense the mass flow of material through harvester 100 at those locations. In some examples, the mass flow rate of material sensed by mass flow sensors 147 is used in the calculation of yield as well as in the calculation of the fill level of the on-board material tank 132. In some examples, mass flow sensors 147 include an impact (or strike) plate that is impacted by material (e.g., grain) conveyed by clean grain elevator 130 and a force or load sensor that detects the force or load of impact of the material on the impact (or strike) plate. In other examples, mass flow sensor 147 can include an image capture device that captures an image of material in harvester 100 and an image processing system that processes the image to identify mass flow. These are merely some examples of a mass flow sensor.

Observation sensor systems 150 can include one or more of a variety of sensors, such as cameras (e.g., mono cameras, stereo cameras, color (e.g. RGB) cameras, multispectral cameras, etc.), lidar sensors, radar sensors, ultrasonic sensors, as well as various other sensor configured to emit and/or receive electromagnetic radiation, as well as a variety of other sensors. Observation sensor systems 150 can illustratively observe (and thus detect characteristics relative to) the worksite 10, items at the worksite 10 (e.g., vegetation, including crops at the worksite), and portions of the harvester 100. While FIG. 1 shows some example positions of observation sensor system 150, it will be understood that observation sensor systems 150 can, alternatively or additionally, be positioned (or otherwise disposed) at a variety of other locations on harvester 100.

Fill level sensors 152 can include one or more of a variety of sensors, such as contact sensors and non-contact sensors. Fill level sensors 152 detect a fill level of grain in grain tank 132. Fill level sensors 152, in the form of contact sensors, include paddles (or other contact members) that are contacted by the grain and the displacement of the contact members or force or load of impact of the material on the contact member can be detected to determine presence of grain material at the level of the tank corresponding to the sensor. Fill level sensors 152, in the form of non-contact sensors, can be configured to capture electromagnetic radiation to detect presence of grain at the level of the tank corresponding to the sensor. In some examples, fill level sensors 152 are configured to alert an operator when the harvester 100 is full (or is approaching full). These are merely some examples. While FIG. 1 shows some example positions of fill level sensors 152, it will be understood that fill level sensors 152 can, additionally or alternatively, be positioned (or otherwise disposed) at a variety of other locations on harvester 100.

Rotor sensor 160 may be disposed relative to the actuator or motor driving threshing rotor 112 to detect the pressure or torque used to drive threshing rotor 112. Sensor 160 generates a signal indicative of the sensed pressure or torque, and that signal may be indicative of the amount of material being processed by threshing rotor 112.

Separator engagement sensor 162 may be mounted to detect whether the separator rotor in separator 116 is engaged. Therefore, separator engagement sensor 162 can be used to detect whether the separator rotor is energized, whether the separator rotor is rotating, etc.

Header engagement/usage sensor 164 is mounted to detect whether the header 104 is engaged and/or which portions of the header 104 are engaging crop. Therefore, header engagement/usage sensor 164 may sense whether functionality on header 104 is energized, whether parts of header 104 are moving, etc. Further, header engagement/usage sensor 164 may include a perception sensor or image capture sensor that captures an image of header 104 and image processing system that processes that image to identify which portions of header 104 are engaging crop. These are only some examples of header engagement/usage sensor 164.

Tailings status sensor 166 may sense the status (quantity, mass flow rate, physical characteristics, etc.) of the tailings that are being moved by tailings elevator 128. Thus, sensor 166 can be a perception sensor, a mass flow sensor, or another sensor that is used to sense characteristics of the tailings.

As discussed above, some of the controllable subsystems on agricultural harvester 100 can be controlled using settings values. The settings values may be set or optimized based on the harvester throughput (e.g., based on the amount of crop material being processed through agricultural harvester 100). Such settings values may be used to control the speed of cleaning fan 120, one or more actuators controlling the clearance of chaffer 122 and sieve 124, one or more actuators controlling the clearance of thresher 110, the speed of threshing rotor 112, the settings on header 104 (such as reel position where header 104 includes a reel, the reel speed, the cut height, the draper belt speed, etc.), and the settings for the residue handling subsystem 138 (such as the residue spread width by spreader 142, the engagement of chopper 140, etc.). If the settings values are set for one harvester throughput, and the harvester throughput changes, this can result in excessive grain loss, undesirable cleaning performance resulting in material other than grain entering the clean grain tank 132, and/or in other undesirable outcomes. Such a scenario (where the harvester throughput changes quickly) is not uncommon during the harvesting operation.

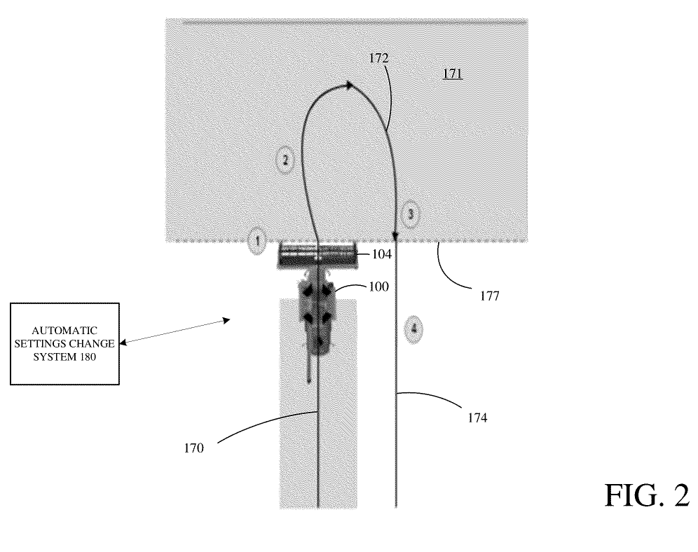

FIG. 2 is a pictorial illustration showing one example of such a scenario. FIG. 2 is a pictorial illustration showing a harvester 100 in a position where harvester 100 has harvested a pass indicated by line 170 through field 175 and is approaching the boundary 177 of a headlands area 171, which has already been harvested. When harvester 100 reaches headlands area 171, harvester 100 will make a headland turn indicated by line 172. After the headland turn 172, harvester 100 will reenter field 175 and perform a subsequent harvesting pass indicated by line 174.

While harvester 100 is traveling along pass 170 in field 175, the harvester throughput will be relatively high because header 104 will be engaging crop material and feeding that crop material back into the other processing subsystems in harvester 100. However, once header 104 reaches the boundary 177 of headlands 171, header 104 will no longer be engaging crop so that the harvester throughput will drop dramatically and suddenly. The harvester throughput will remain relatively low, as harvester 100 executes the headland turn 172. Then, when harvester 100 again reaches the boundary 177 of headlands 171, and begins pass 174 through field 175, header 104 will again begin engaging crop and feeding that crop back into harvester 100. Thus, the harvester throughput will increase suddenly as harvester 100 begins pass 174.

Therefore, in accordance with one example, automatic settings change system 180 uses sensor signals on harvester 100 to detect a harvest state of harvester 100. The harvest state may indicate whether harvester 100 is in an active harvest state, in which header 104 is engaging crop material and the harvester throughput is relatively high, or whether harvester 100 is in an inactive harvest state, such as where header 104 is not engaging crop and the harvester throughput is low compared to the harvester throughput during the active harvest state. Automatic settings change system 180 can then access settings values corresponding to the harvest state and automatically apply those values to controllable subsystems on harvester 100.

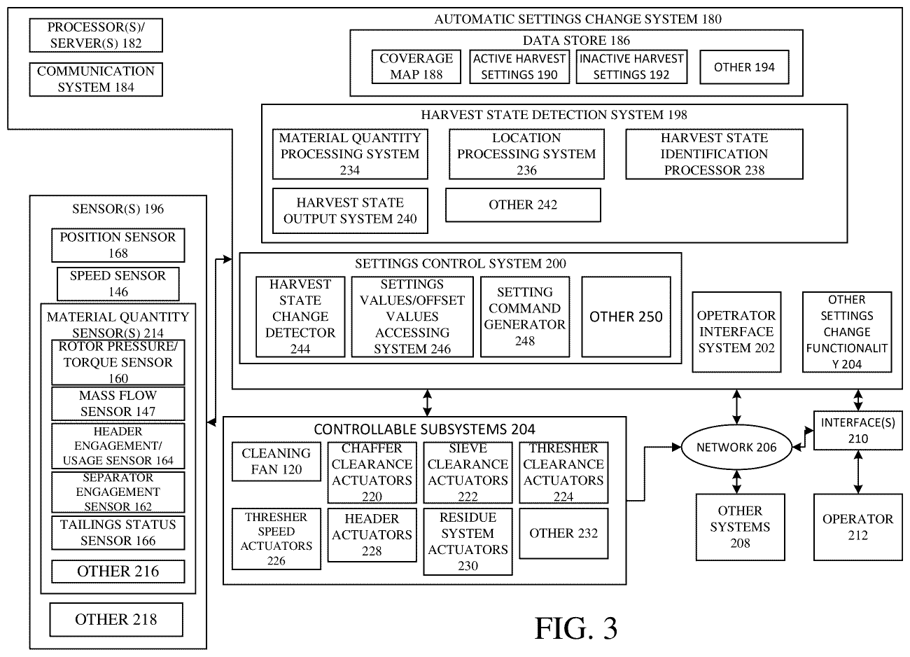

FIG. 3 is a block diagram showing one example of an agricultural system 199 which includes automatic settings change system 180, sensors 196, and controllable subsystems 204. In more detail. In the example shown in FIG. 3, automatic settings change system 180 can receive inputs from one or more sensors 196 and generate control signals to control controllable subsystems 204. FIG. 3 also shows that system 180 can communicate over network 206 with controllable subsystems 204 and/or other systems 208. Further, automatic settings change system 180 can generate interfaces 210 for operator 212. The interfaces 210 can be generated directly by system 180 or through network 206. Interfaces 210 can be displayed on a display device for the operator 212, such as a display device in operator compartment 119, on a mobile device or in other ways. Operator 212 can interact with interfaces 210 to control and manipulate portions of automatic settings change system 180 and/or agricultural harvester 100.

In the example shown in FIG. 3, sensors 196 can include position sensor 168, speed sensor 146, one or more material quantity sensors 214, such as rotor pressure/torque sensor 160, mass flow sensor 147, header engagement/usage sensor 164, separator engagement sensor 162, tailings status sensor 166, and/or any of a wide variety of other sensors 216 that sense values responsive to the harvester throughput. Sensors 196 can include other sensors 218 as well.

Controllable subsystems 204 can include cleaning fan 120, chaffer clearance actuators 220 which can be actuated to change the chaffer clearance, sieve clearance actuators 222 which can be actuated to change the sieve clearance, thresher clearance actuators 224 which can be actuated to change the thresher clearance, thresher speed actuators 226 which can be actuated to change threshing rotor speed, header actuators 228 which can be actuated to control header operations (such as to change cut height, to control reel behavior, etc.), residue system actuators 230 (which can control spreader 142, chopper 140, etc.), and any of a wide variety of other controllable subsystems 232. The actuators in controllable subsystems 204 can include hydraulic actuators, pneumatic actuators, electric actuators, and/or any of a wide variety of other actuators.

FIG. 3 also shows that system 180 can include one or more processors or servers 182, communication system 184, data store 186 (which can include coverage map 188, active harvest settings 190, inactive harvest offsets 192, and other items 194), harvest state detection system 198, settings control system 200, operator interface system 202, and other settings change functionality 204. Harvest state detection system 198 can include material quantity processing system 234, location processing system 236, harvest state identification processor 238, harvest state output system 240, and other items 242. Settings control system 200 can include harvest state change detector 244, settings values/offset values accessing system 246, setting command generator 248, and other items 250. Before describing the operation of automatic settings change system 180 in more detail, a description of some of the items in agricultural system 199, and their operation, will first be described.

Communication system 184 illustratively facilitates communication among the items in automatic settings change system 180 with one another, with sensors 196, controllable subsystems 204, and communication over network 206. Therefore, communication system 184 can be a controller area network (CAN) bus and bus controller, a cellular communication system, a wide area network communication system, a local area network communication system, a Bluetooth and/or Wi-Fi communication system, a near field communication system, or other systems or combinations of systems.

Coverage map 188 is illustratively a map that defines the boundary of the field being harvested by agricultural harvester 100. Coverage map 188 illustratively reflects the route of harvester 100 and identifies areas in the field that harvester 100 has already harvested. In one example, coverage map 188 can also geographically identify the locations of non-crop areas, such as waterways or other areas and indicate whether those non-crop areas are passable (so that agricultural harvester 100 can drive through them) or impassable (so that agricultural harvester 100 must drive around them).

Active harvest settings 190 are illustratively values that can be used to control the controllable subsystems 204 when harvester 100 is in an active harvest state. The active harvest settings 190 thus identify the cleaning fan speed, the chaffer and sieve clearance, the thresher clearance, the threshing rotor speed, header functions, residue system functions, and other controllable subsystem values that are controlled using settings values. Inactive harvest offsets 192 may be values that are applied to controllable subsystems 204 when harvester 100 is determined to be in an inactive harvest state. Inactive harvest offsets 192 can be specified as absolute values or as offsets from the values in active harvest settings 190.

Harvest state detection system 198 receives inputs from one or more sensors 196 and can access coverage map 188 and identifies whether harvester 100 is in an active harvest state or an inactive harvest state. Similarly, harvest state detection system 198 can generate an output indicating whether agricultural harvester 100 is in a passable non-crop area or in another geographic location of interest in the field. Thus, material quantity processing system 234 receives sensor signals from one or more material quantity sensors 214 and processes those sensor signals to identify a quantity of material being processed by harvester 100 (e.g., identifies the harvester throughput). By way of example, material quantity processing system 234 can receive the sensor signals and look up a corresponding harvester throughput value corresponding to those sensor signal values. In another example, material quantity processing system 234 can be a model or another dynamic system that receives the material quantity sensor signals from one or more of sensors 214 and uses the model or machine learning system to generate an output indicative of harvester throughput.

Location processing system 236 can maintain and accesses coverage map 188. System 236 can receive an input from position sensor 168 and identifies where, on coverage map 188, agricultural harvester 100 is located. For instance, location processing system 236 can compare a location output by position sensor 168 to coverage map 188 to locate the agricultural harvester 100 on the coverage map 188. Location processing system 236 can determine that agricultural harvester 100 is in the middle of a harvesting pass, in a headland area, in a passable non-crop area, or located elsewhere. Thus, system 236 can update coverage map 188 to identify harvested locations as well as to identify whether harvester 100 is in a crop area, a non-crop area, an already harvested area, etc.

Harvest state identification processor 238 can receive an output from material quantity processing system 234 that is indicative of the current harvester throughput, as well as an output from location processing system 236 indicating whether the agricultural harvester 100 is located in an area where it should be harvesting material or in an area where it is likely not harvesting. Harvest state identification processor 238 processes the outputs from systems 234 and 236 and generates an output indicative of the harvest state of agricultural harvester 100. For example, harvest state identification processor 238 can use the outputs from systems 234 and 236 to perform a lookup to identify the harvest state. In another example, harvest state identification processor 238 can be a classifier or another machine learning system or dynamic model that receives the inputs and generates an output indicative of the harvest state of agricultural harvester 100.

Harvest state output system 240 generates an output indicative of the harvest state and may also generate an output indicative of the current location of agricultural harvester 100. For instance, harvest state output system 240 may generate an output indicating that agricultural harvester 100 is in an inactive state but also indicating that agricultural harvester 100 is currently located in a passable non-crop area or in another location of interest. Harvest state output system 240 can also generate an output indicating, based upon the current speed of agricultural harvester will 100 (as output by speed sensor 146) and based upon the location where the harvest state will next change, a time indicator indicating how quickly the harvest state of agricultural harvester 100 is going to change. By way of example, if agricultural harvester 100 is in a relatively short waterway, harvest state output system 240 may generate an output indicating that even though harvester 100 is in an inactive harvest state, it will be switching back to an active harvest state within the next five seconds (or other time period).

Settings control system 200 receives the output from harvest state output system 240, indicating the current harvest state of harvester 100 as well as, in one example, an indicating the geographic location of harvester 100 relative to locations of interest in the field. Settings control system 200 may also receive an output from system 240 indicating how quickly the harvest state of agricultural harvester 100 is likely to change.

Harvest state change detector 244 detects whether the current harvest state of agricultural harvester 100 has changed so that the settings values being applied to controllable subsystems 204 do not correspond to the current harvest state. Thus, harvest state change detector 244 may store a current harvest state of agricultural harvester 100 and compare the new harvest state output by harvest state output system 240 to the stored harvest state to determine whether the harvest state has changed. Settings values/offset values accessing system 246 can then access data store 186 to identify the settings values corresponding to the current harvest state. For instance, if agricultural harvester 100 has a harvest state that changed from inactive to active, then system 246 accesses data store 186 to retrieve the active harvest settings 190. If agricultural harvester 100 has a harvest state that changed from active to inactive, then system 246 accesses data store 186 to identify the inactive harvest offset values 192.

Setting command generator 248 evaluates whether the harvest state has changed, and can also evaluate how quickly the harvest state will likely change back to its previous state. Based on those evaluations, setting command generator 248 determines whether new settings values or offsets should be applied to the controllable subsystems 204. By way of example, if setting command generator 248 determines that the harvest state has changed from inactive to active, and if setting command generator 248 determines that harvester 100 will likely not change back to the inactive state for a threshold time period, then setting command generator 248 can apply the active harvest settings 190 to controllable subsystems 204. However, if, for example, setting command generator 248 determines that the harvest state has changed from active to inactive, but that the harvest state is likely to change back to active within a threshold time period, then setting command generator 248 may not change the settings values applied to controllable subsystems 204, but instead may maintain the active harvest settings values 190. In another example, setting command generator 248 may determine that the harvest state has changed from active to inactive and that it is not likely to change back to active within the threshold time period (e.g., in a scenario where harvester 100 is making a headland turn). In that case, setting command generator 248 may determine that the inactive harvest offset values 192 should be applied to the controllable subsystems 204 until the harvest state changes back to active.

Operator interface system 202 can include operator interface mechanisms that can be used by operator 212 in operator compartment 119 to control and manipulate harvester 100. Therefore, those operator interface mechanisms can include joysticks, a steering wheel, peddles, levers, linkages, buttons, etc. Further, the operator interface mechanisms can include a display screen that displays information to the operator 212 and that receives inputs from operator 212 through operator actuatable input mechanisms such as links, icons, buttons, etc. The display screen may be a touch sensitive screen where the operator interface mechanisms can be actuated using touch gestures. Further, operator interface system 202 can include a microphone and speaker where speech recognition and speech synthesis are provided and can include a wide variety of other mechanisms that provide audio, visual, and/or haptic outputs to an operator 212 and/or receive inputs from an operator 212.

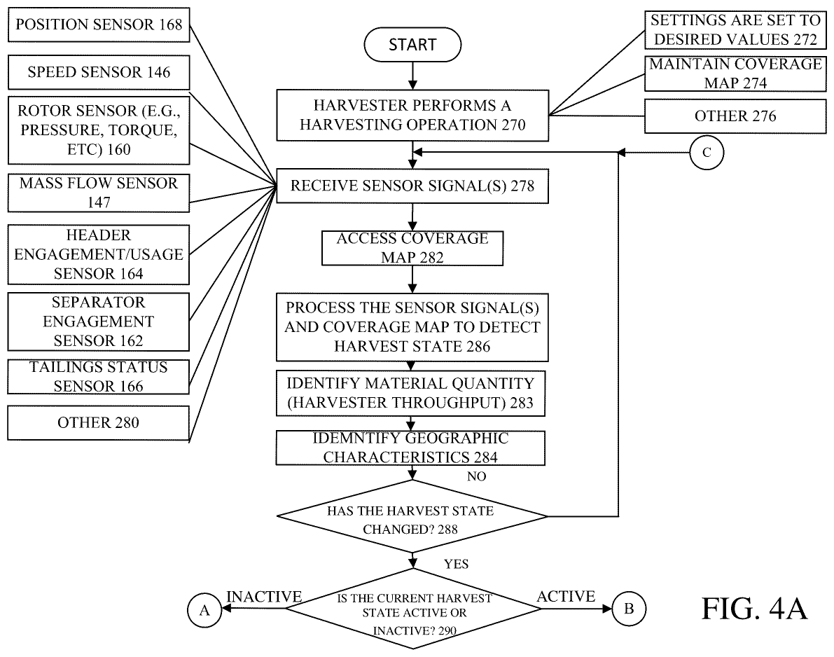

FIGS. 4A and 4B (collectively referred to herein as FIG. 4) show a flow diagram illustrating one example of the operation of automatic settings change system 180 in identifying a harvest state corresponding to agricultural harvester 100 and generating control signals to control the settings values applied to controllable subsystems 204, based upon the detected harvest state. It is first assumed that agricultural harvester 100 performs a harvesting operation in the field, as indicated by block 270 in the flow diagram of FIG. 4. It is assumed that the settings are set to desired values, given the current harvest state of agricultural harvester 100, as indicated by block 272. It is also assumed that location processing system 236 maintains coverage map 180 indicating the areas of the field that have already been harvested by agricultural harvester 100 (and/or other harvesters in the same field). Maintaining a coverage map is indicated by block 274 in the flow diagram of FIG. 4. Harvester 100 can perform the harvesting operations in other ways and perform other functions as well, as indicated by block 276.

Material quantity processing system 234 then receives one or more sensor signals, as indicated by block 278. The sensor signals can be from position sensor 168, speed sensor 146, rotor sensor 160, mass flow sensor 147, header engagement/usage sensor 164, separator engagement sensor 162, tailings status sensor 166, and/or any of wide variety of other sensors 280.

Location processing system 236 also accesses coverage map 188, as indicated by block 282 in the flow diagram of FIG. 4. Material quantity processing system 234 then generates an output responsive to the quantity of material being processed by harvester 100 (e.g., responsive to the harvester throughput) based upon the sensor signal from material quantity sensors 214. Identifying material quantity or harvester throughput is indicated by block 283 in the flow diagram of FIG. 4.

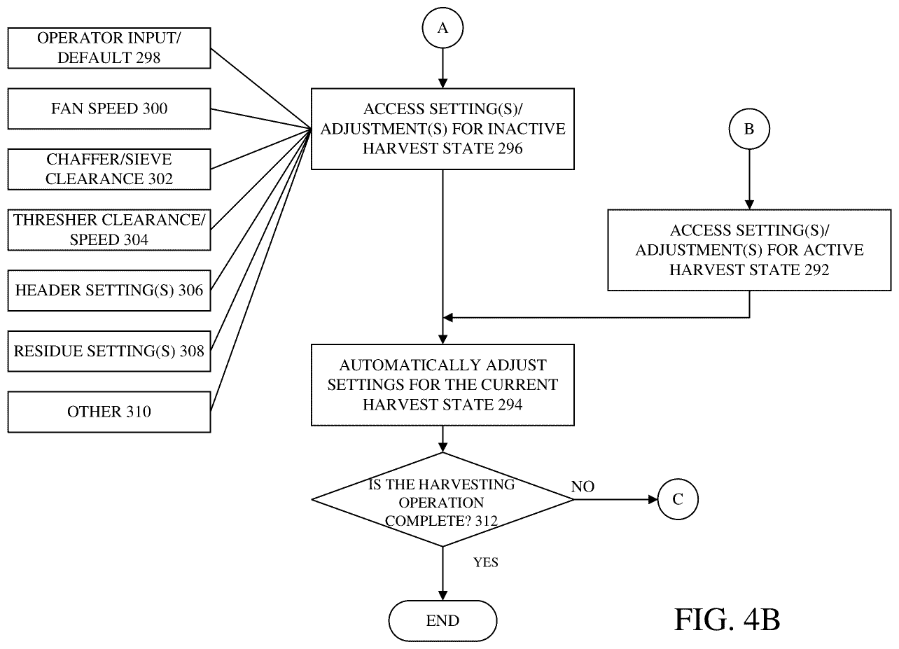

FIG. 5 shows one example of a sensor signal that can vary in response to the quantity of material being processed by harvester 100 (e.g., in response to the harvester throughput). FIG. 5 shows one example of mass flow rate plotted versus time. The mass flow rate may be at first level 285 when agricultural harvester 100 is in the active harvest state, and the mass flow rate may be at a second, much reduced, level 287 when agricultural harvester 100 is in the inactive harvest state. The mass flow signal may again return to the first level as indicated at 289 when the agricultural harvester 100 again resumes the active harvest state.

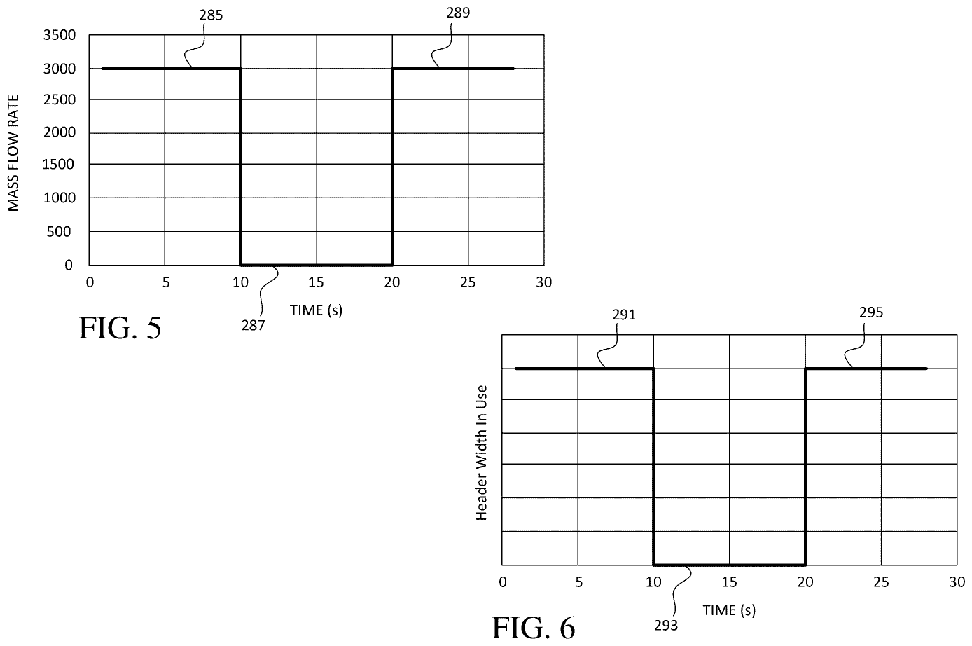

FIG. 6 is similar to FIG. 5 except that FIG. 6 graphically illustrates the output from a header usage sensor 164 which generates a sensor signal indicating a width of header 104 that is actively engaging crop. The header usage may be at first level 291 which indicates that the full header is in use when harvester 100 is in the active harvest state. However, the header usage signal may drop to a level 293 indicating that none of the header width is in use when agricultural harvester 100 is in an inactive harvest state. The header usage signal may again return to the first level at 295 when the agricultural harvester 100 returns to the active harvest state.

Location processing system 236 also identifies any geographic characteristics of interest corresponding to harvester 100 (such as whether harvester 100 is in an area where it is likely not harvesting, in an area where it is likely harvesting, how quickly the harvester 100 will likely transition from one harvest state to another, etc). Identifying the geographic characteristics corresponding to harvester 100 is indicated by block 284 in the flow diagram of FIG. 4. Harvest state identification processor 238 then processes the outputs of material quantity processing system 234 (which is responsive to the quantity of material being processed by harvester 100) and from location processing system 236 to detect a current harvest state corresponding to harvester 100. Detecting the current harvest state is indicated by block 286 in the flow diagram of FIG. 4. Harvest state output system 240 generates an output indicative of the current harvest state, and any location information of interest.

Harvest state change detector 244 detects whether the current harvest state has changed since the last time the harvest state was identified. Determining whether the harvest state has changed is indicated by block 288 in the flow diagram of FIG. 4. If the harvest state has not changed, processing reverts to block 278 where harvest state detection system 198 continues to receive sensor signals, access the coverage map, and identify the harvest state.

However, if, at block 288, it is determined that the harvest state has changed, then depending upon whether the current harvest state is active or inactive (as determined at block 290) settings values/offset values accessing system 246 accesses the appropriate settings 190 or offsets 192. For instance, assuming, at block 290, that it is determined that the current harvest state is active, then settings values/offset values accessing system 246 accesses the active harvest settings 190, corresponding to the active harvest state, as indicated by block 292 in the flow diagram of FIG. 4. Setting command generator 248 generates control signals to automatically adjust the settings values for the active harvest state and apply those values to controllable subsystems 204, as indicated by block 294 in the flow diagram of FIG. 4.

However if, at block 290, it is determined that the current harvest state is inactive, then settings values/offset values accessing system 246 accesses the inactive harvest offsets 192 corresponding to the inactive harvest state, as indicated by block 296 in the flow diagram of FIG. 4. Setting command generator 248 generates control signals to apply those inactive harvest offsets 192 to controllable subsystems 204. Again, the inactive harvest offset values 192 can be received as operator inputs or as default values, as indicated by block 298. The active harvest settings 190 and/or offsets 192 can identify fan speed 300, chaffer/sieve clearance 302, thresher clearance/threshing rotor speed 304, header settings 306, residue settings 308, and/or any of wide variety of other settings values and/or offsets, as indicated by block 310. Until the harvesting operation is complete, as determined at block 312, processing reverts to block 278 where harvest state detection system 198 continues to receive sensor signals and access coverage map 188.

It can thus be seen that the present description describes a system that automatically detects the harvest state of an agricultural harvester and accesses setting values or offset values corresponding to the harvest state. The present system automatically applies the settings values or offsets for the corresponding harvest state to controllable subsystems on the harvester. This reduces grain loss and reduces the likelihood that material other than grain will be placed in the clean grain tank of the agricultural harvester.

The present discussion has mentioned processors and servers. In one example, the processors and servers include computer processors with associated memory and timing circuitry, not separately shown. The processors or servers are functional parts of the systems or devices to which they belong and are activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, detectors, and/or logic. It will be appreciated that such systems, components, generators, detectors, and/or logic can be comprised of hardware items (such as processors and associated memory, or other processing components, some of which are described below) that perform the functions associated with those systems, components, generators, detectors, and/or logic. In addition, the systems, components, generators, detectors, and/or logic can be comprised of software that is loaded into a memory and is subsequently executed by a processor or server, or other computing component, as described below. The systems, components, generators, detectors, and/or logic can also be comprised of different combinations of hardware, software, firmware, etc., some examples of which are described below. These are only some examples of different structures that can be used to form the systems, components, generators, detectors, and/or logic described above. Other structures can be used as well.

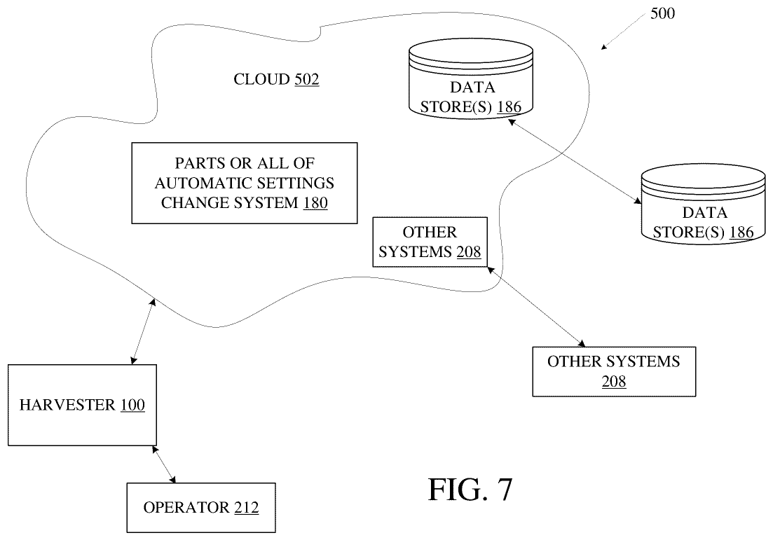

FIG. 7 is a block diagram of harvester 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 7, some items are similar to those shown in previous FIGS. and they are similarly numbered. FIG. 7 specifically shows some or all of system 180, and other systems 208 can be located at a remote server location 502. Therefore, harvester 100 accesses those systems through remote server location 502.

FIG. 7 also depicts another example of a remote server architecture. FIG. 7 shows that it is also contemplated that some elements of previous FIGS are disposed at remote server location 502 while others are not. By way of example, data store 186 or other systems 208 can be disposed at a location separate from location 502, and accessed through the remote server at location 502. Regardless of where the items are located, they can be accessed directly by harvester 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

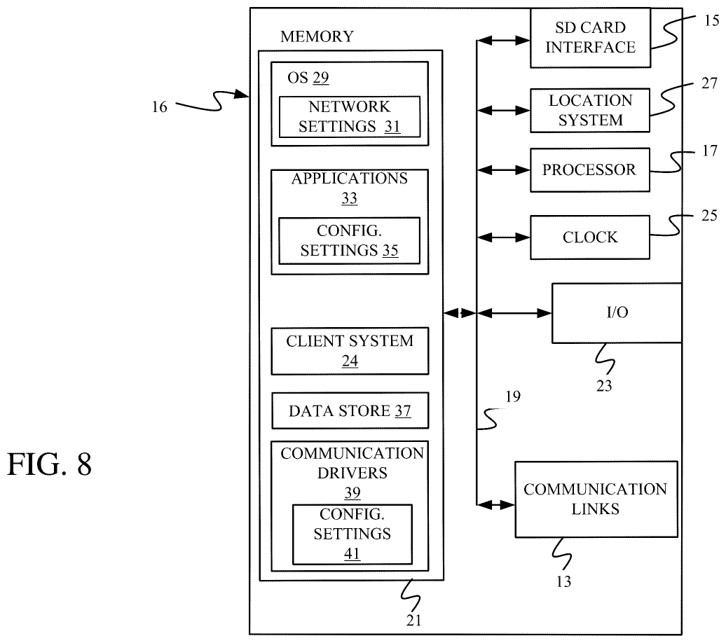

FIG. 8 is a simplified block diagram of one illustrative example of a handheld or mobile computing device that can be used as a user's or client's handheld device 16, in which the present system (or parts of it) can be deployed. For instance, a mobile device can be deployed in the operator compartment of harvester 100 for use in generating, processing, or displaying the harvest state and settings data. FIGS. 8-10 are examples of handheld or mobile devices.

FIG. 8 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

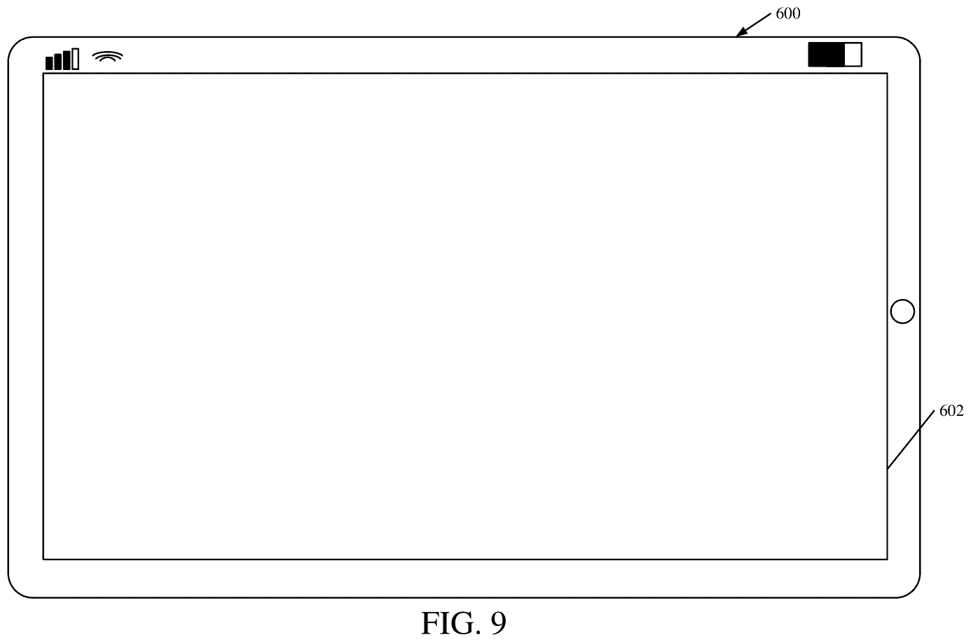

FIG. 9 shows one example in which device 16 is a tablet computer 600. In FIG. 9, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

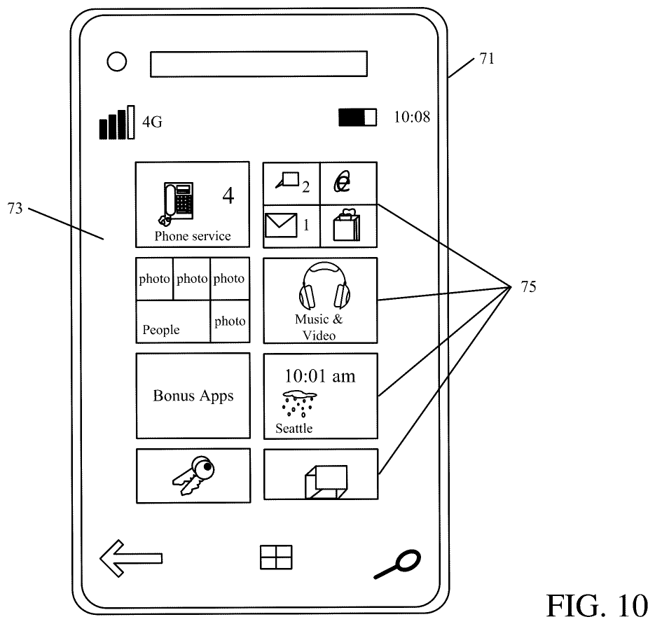

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

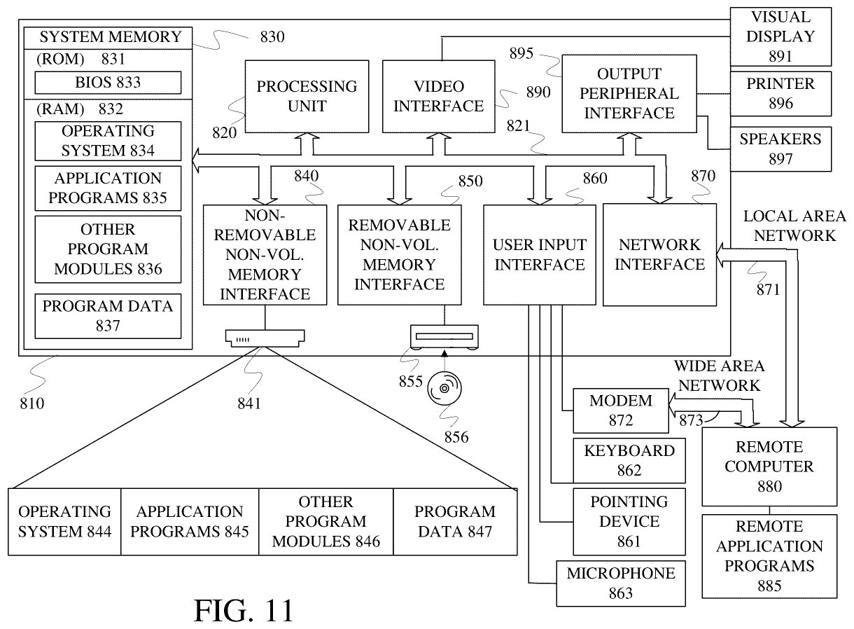

FIG. 11 is one example of a computing environment in which elements of previous FIGS., or parts of it, (for example) can be deployed. With reference to FIG. 11, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 11 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving a harvest state sensor signal indicative of whether an agricultural harvester is in an active harvest state or an inactive harvest state;
detecting a harvest state of the agricultural harvester based on the harvest state sensor signal; and
automatically controlling settings on the agricultural harvester based on the harvest state of the agricultural harvester.

2. The computer implemented method of claim 1 wherein the agricultural harvester includes a controllable subsystem, wherein detecting a harvest state comprises detecting that the agricultural harvester is in an active harvest state, and wherein automatically controlling settings on the agricultural harvester comprises:
accessing a settings value corresponding to the active harvest state; and
applying the settings value to the controllable subsystem on the agricultural harvester.

3. The computer implemented method of claim 1 wherein the agricultural harvester includes a controllable subsystem, wherein detecting a harvest state comprises detecting that the agricultural harvester is in an inactive harvest state, and wherein automatically controlling settings on the agricultural harvester comprises:
accessing a settings offset value corresponding to the inactive harvest state; and
applying the settings offset value to the controllable subsystem on the agricultural harvester.

4. The computer implemented method of claim1 wherein accessing a settings offset value corresponding to the inactive harvest state comprises:
detecting the settings offset value as an operator input.

5. The computer implemented method of claim 1 wherein the agricultural harvester includes a location sensor configured to sense a geographic location of the agricultural harvester and generate a location signal indicative of the geographic location of the agricultural harvester and wherein receiving a harvest state sensor signal comprises:
receiving the location signal and wherein automatically controlling settings on the agricultural harvester comprises accessing a coverage map indicative of an area in a field that has been harvested, automatically controlling settings on the agricultural harvester based on the harvest state of the agricultural harvester, based on the coverage map, and based on the geographic location of the agricultural harvester.

6. The computer implemented method of claim 1 wherein receiving the harvest state sensor signal comprises receiving an amount signal indicative of an amount of harvested material in the agricultural harvester.

7. The computer implemented method of claim 6 wherein the agricultural harvester includes a threshing rotor, and a threshing rotor characteristic sensor configured to generate a threshing rotor characteristic sensor signal indicative of an amount of material being processed by the threshing rotor, wherein receiving a harvest state sensor signal comprises:
receiving the threshing rotor characteristic sensor signal, wherein detecting the harvest state comprises detecting the harvest state of the agricultural harvester based on the threshing rotor characteristic sensor signal.

8. The computer implemented method of claim 6 wherein the agricultural harvester includes a mass flow sensor configured to generate a mass flow sensor signal indicative of a mass flow of material through the agricultural harvester and wherein receiving a harvest state sensor signal comprises:
receiving the mass flow sensor signal, wherein detecting the harvest state comprises detecting the harvest state of the agricultural harvester based on the mass flow sensor signal.

9. The computer implemented method of claim 6 wherein the agricultural harvester includes a header that engages crop material when the agricultural harvester is in the active harvest state and a header sensor configured to sense an operating characteristic of the header and generate a header characteristic sensor signal indicative of the operating characteristic of the header, and wherein receiving a harvest state sensor signal comprises:
receiving the header characteristic sensor signal, wherein detecting the harvest state comprises detecting the harvest state of the agricultural harvester based on the header characteristic sensor signal.

10. The computer implemented method of claim 6 wherein the agricultural harvester includes a separator, and a separator sensor configured to sense an operating characteristic of the separator and generate a separator characteristic sensor signal indicative of the operating characteristic of the separator, and wherein receiving a harvest state sensor signal comprises:
receiving the separator characteristic sensor signal, wherein detecting the harvest state comprises detecting the harvest state of the agricultural harvester based on the separator characteristic sensor signal.

11. The computer implemented method of claim 6 wherein the agricultural harvester includes a tailings handling subsystem and a tailings handling sensor configured to sense an operating characteristic of the tailings handling subsystem and generate a tailings handling characteristic sensor signal indicative of the operating characteristic of the tailings handling subsystem, and wherein receiving a harvest state sensor signal comprises:
receiving the tailings handling characteristic sensor signal, wherein detecting the harvest state comprises detecting the harvest state of the agricultural harvester based on the tailings handling characteristic sensor signal.

12. An agricultural system, comprising:
an agricultural harvester having a controllable subsystem that is controlled based on a setting value;
a harvest state sensor configured to sense a harvest state of the agricultural harvester and generate a harvest state sensor signal indicative of whether the agricultural harvester is in an active harvest state or an inactive harvest state;
a harvest state detection system configured to detect a harvest state of the agricultural harvester based on the harvest state sensor signal; and
a settings control system configured to automatically control the setting value based on the harvest state of the agricultural harvester.

13. The agricultural system of claim 12 wherein settings control system is configured to, when the agricultural harvester is in the active harvest state, access a first setting value and apply the first setting value to the controllable subsystem on the agricultural harvester and to, when the agricultural harvester is in the inactive harvest state, access a setting offset value and applying the setting offset value to the controllable subsystem on the agricultural harvester.

14. The agricultural system of claim 12 wherein the harvest state sensor comprises:
a material quantity sensor configured to sense a value indicative of an amount of material in the agricultural harvester and generate an amount signal indicative of the amount of material in the agricultural harvester.

15. The agricultural system of claim 14 wherein the agricultural harvester includes a threshing rotor, and wherein the material quantity sensor comprises:
a threshing rotor characteristic sensor configured to generate a threshing rotor characteristic sensor signal indicative of an amount of material being processed by the threshing rotor.

16. The agricultural system of claim 14 wherein the material quantity sensor comprises:
a mass flow sensor configured to generate a mass flow sensor signal indicative of a mass flow of material through the agricultural harvester.

17. The agricultural system of claim 14 wherein the agricultural harvester includes a header that engages crop material when the agricultural harvester is in the active harvest state and wherein the material quantity sensor comprises:
a header sensor configured to sense an operating characteristic of the header and generate a header characteristic sensor signal indicative of the operating characteristic of the header.

18. The agricultural system of claim 14 wherein the agricultural harvester includes a separator and wherein the material quantity sensor comprises:
a separator sensor configured to sense an operating characteristic of the separator and generate a separator characteristic sensor signal indicative of the operating characteristic of the separator.

19. The agricultural system of claim 12 wherein the settings control system is configured to access a coverage map indicative of an area in a field that has been harvested by the agricultural harvester during a harvesting operation and automatically control the setting value based on the coverage map.

20. A settings change system, comprising:
a harvest state detection system configured to receive a harvest state sensor signal indicative of a quantity of material in process in an agricultural harvester during a harvesting operation and detect a harvest state of the agricultural harvester based on the harvest state sensor signal; and
a settings control system configured to automatically identify a setting value and apply the setting value to a controllable subsystem on the agricultural harvester based on the harvest state of the agricultural harvester.
